(19) United States
(12) Patent Application Publication
(10) Pub. No.: US 2014/0240118 A1
(43) Pub. Date: Aug. 28, 2014

(54) VEHICLE AUXILIARY HORN APPARATUS

(71) Applicant: Jae Woong Lee, Seongnam-si (KR)

(72) Inventor: Jae Woong Lee, Seongnam-si (KR)

(21) Appl. No.: 13/978,094

(22) PCT Filed: Aug. 8, 2012
(86) PCT No.: PCT/KR12/06298

§ 371 Date: May 18, 2014

(30) Foreign Application Priority Data
Oct. 27, 2011 (KR) 10-2011-0110685

(51) Int. Cl. B60Q 5/00

(52) U.S. Cl. CPC B60Q 5/008
USPC 340/463

(57) ABSTRACT

A vehicle auxiliary horn apparatus provides a sound through a horn to alert pedestrians that a vehicle, such as an electric vehicle or a new vehicle that makes virtually no noise, is moving; and provides set sound information during parking when a human body is detected. The vehicle auxiliary horn apparatus of the present invention comprises: a sound storage unit for storing and managing music information, announcement information, and repeating sound information; a display panel unit for displaying information for setting one type of sound information stored in the sound storage unit; a sound extracting unit for extracting the sound information, selected from the display panel, from the sound storage unit; a sound output processing unit for outputting the sound extracted from the sound extracting unit through a speaker; a manual control unit disposed on the front portion of the vehicle, for transmitting a manual control signal to a central control, unit when manipulated; an automatic control unit disposed on the front portion of the vehicle, for transmitting an automatic control signal to the central control unit, when manipulated; a sound-providing, speed-setting unit for setting a speed for automatically outputting a sound, under automatic control; a moving speed checking unit for checking the moving speed of the vehicle; and the central control unit for receiving a control signal transmitted by the manual control unit or the automatic control unit, distinguishing the type of the control signal, and when the control signal is an automatic control signal, acquiring the speed information set by the sound-providing, speed-setting unit, checking the current speed, and determining whether to output a sound. Through the present invention, by providing a sound through a horn to alert pedestrians that a vehicle is moving, such as an electric vehicle or a new vehicle that makes virtually no noise, the effect is provided of being able to prevent the occurrence of dangerous situations for pedestrians. Also, in school zones, on roads within apartment complexes, on roads in which there are many pedestrian walkways, and the like, in which it is difficult to use a typical loud horn while a vehicle is moving slowly, the auxiliary horn can be used in a practical manner to provide better results. In particular, the effect is provided of being able to assist the safe movement of those who cannot focus well on the surrounding traffic conditions in which they walk and those whose reactions and movements are slow, such as children, patients, and the elderly, and the disabled who require care and protection.

### BACKGROUND OF THE INVENTION

The present invention relates to an auxiliary horn apparatus for a vehicle, and more particularly, to an auxiliary horn apparatus for a vehicle, which provides pedestrians with a sound through a horn in order to let the pedestrians know that an electric vehicle or the latest-model vehicle which makes almost no noise is running or that a vehicle is running at low speed, and which provides previously set sound information during parking only in the case that a human body is detected.

Korean utility Model Laid-open No. 1998-0032728 (on Sep. 5, 1998) discloses a horn apparatus for a vehicle.

The horn apparatus for the vehicle according to the prior art provides a horn for a vehicle and rapidly operates the horn even at the time of gear shift.

However, in order to sound the horn during running, because the horn sounds only when a driver honks the horn mounted on a handle, even though electric vehicles currently on the market or the latest-model vehicles which make almost no noise are adopted, if the driver does not frequently let pedestrians know, the pedestrians cannot easily know whether or not the vehicles are running.

Therefore, the vehicles may provide pedestrians with a dangerous situation.

### CITED REFERENCE

(Patent Reference 0001) (Utility Model reference)

Korean utility Model Laid-open No. 1998-0032728 (on Sep. 5, 1998)

### SUMMARY OF THE INVENTION

Accordingly, the present invention has been made to solve the above-mentioned problems occurring in the prior arts, and it is an object of the present invention to provide an auxiliary horn apparatus for a vehicle, which provides pedestrians with a sound through a horn in order to let the pedestrians know that an electric vehicle or the latest-model vehicle which makes almost no noise is running.

It is another object of the present invention to provide an auxiliary horn apparatus for a vehicle, which comes in useful even in the case that it is difficult to make a loud horn sound in school zones, on roads inside apartment complexes, or roads where many pedestrians walk during a low speed running of the vehicle. Particularly, the auxiliary horn apparatus for the vehicle according to the present invention can help children, patients, aged people who have slow movements and have lacked concentration on and slow response to surrounding traffic environment and who need care and attention.

It is a further object of the present invention to provide an auxiliary horn apparatus for a vehicle, which provides previously set sound information during parking only when a human body is detected, so as to prevent a theft case.

To achieve the above objects, the present invention provides an auxiliary horn apparatus for a vehicle including: a sound storage unit for storing and managing music information, announcement information, and repeating sound information; a display panel unit for displaying information for setting one type of sound information stored in the sound storage unit; a sound extracting unit for extracting the sound information, which is selected from the display panel, from the sound storage unit; a sound output processing unit for outputting the sound extracted from the sound extracting unit through a speaker; a manual control unit disposed on the front portion of the vehicle, for transmitting a manual control signal to a central control unit when manipulated; an automatic control unit disposed on the front portion of the vehicle, for transmitting an automatic control signal to the central control unit, when manipulated; a sound-providing speed setting unit for controlling a speed in order to automatically output a sound in an automatic control mode; a moving speed checking unit for checking the moving speed of the vehicle; and a central control unit for receiving the control signal transmitted from the manual control unit or the automatic control unit, distinguishing the type of the control signal, and when the control signal is the automatic control signal, acquiring the speed information set by the sound-providing speed setting unit, checking the current speed, and determining whether to output a sound.

As described above, the auxiliary horn apparatus for the vehicle according to the present invention provides pedestrians with a sound through a horn in order to let the pedestrians know that an electric vehicle or the latest-model vehicle which makes almost no noise is running, thereby preventing that the pedestrians are in a dangerous situation.

Moreover, the auxiliary horn apparatus for the vehicle according to the present invention comes in useful even in the case that it is difficult to make a loud horn sound in school zones, on roads inside apartment complexes, or roads where many pedestrians walk during a low speed running of the vehicle. Particularly, the auxiliary horn apparatus for the vehicle according to the present invention can help children, patients, aged people who have slow movements and have lacked concentration on and slow response to surrounding traffic environment and who need care and attention.

Furthermore, the auxiliary horn apparatus for the vehicle according to the present invention provides previously set sound information during parking only in the case that a human body is detected, so as to prevent a theft case.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exemplary diagram showing a position where an auxiliary horn apparatus for a vehicle according to the present invention is installed;

FIG. 2 is a block diagram of the auxiliary horn apparatus for the vehicle according to a preferred embodiment of the present invention; and

FIG. 3 is a block diagram of the auxiliary horn apparatus for the vehicle according to another preferred embodiment of the present invention.

### EXPLANATION OF REFERENCE NUMERALS IN DRAWINGS

110: sound storage unit

120: display panel unit

130: sound extracting unit

140: sound output processing unit

150: manual control unit

160: automatic control unit

170: sound-providing speed setting unit

180: moving speed checking unit

190: central control unit

### DETAILED DESCRIPTION OF THE PREFERRED EMBODIMENT

To achieve the above objects, the present invention provides an auxiliary horn apparatus for a vehicle including: a sound storage unit for storing and managing music information, announcement information, and repeating sound information; a display panel unit for displaying information for setting one type of sound information stored in the sound storage unit; a sound extracting unit for extracting the sound information, which is selected from the display panel, from the sound storage unit; a sound output processing unit for outputting the sound extracted from the sound extracting unit through a speaker; a manual control unit disposed on the front portion of the vehicle, for transmitting a manual control signal to a central control unit when manipulated; an automatic control unit disposed on the front portion of the vehicle, for transmitting an automatic control signal to the central control unit, when manipulated; a sound-providing speed setting unit for controlling a speed in order to automatically output a sound in an automatic control mode; a moving speed checking unit for checking the moving speed of the vehicle; and a central control unit for receiving the control signal transmitted from the manual control unit or the automatic control unit, distinguishing the type of the control signal, and when the control signal is the automatic control signal, acquiring the speed information set by the sound-providing speed setting unit, checking the current speed, and determining whether to output a sound.

In additional aspect, the auxiliary horn apparatus for the vehicle according to the present invention further includes an external terminal connection unit for renewing and processing the sound information stored in the sound storage unit through communication with an external terminal.

Moreover, in a further aspect, the auxiliary horn apparatus for the vehicle according to the present invention further includes a sound loudness converting unit for converting a loudness level of the sound extracted from the sound extracting unit every regular cycle.

Furthermore, in a still further aspect, the auxiliary horn apparatus for the vehicle according to the present invention further includes:

an external terminal connection unit 210 for renewing and processing the sound information stored in the sound storage unit through communication with an external terminal;

a sound loudness converting unit 220 for converting a loudness level of the sound extracted from the sound extracting unit every regular cycle;

a parking sound extracting unit 230 for extracting sound information, which will be outputted at the time of parking, from the sound storage unit;

a human body detection sensor 240 for sensing a human body; and

a human body detection signal transmitting unit 250 for transmitting a detection signal to the central control unit when a human body is detected by a human body detection sensor at the time of parking after checking whether or not the vehicle is parked.

Hereinafter, preferred embodiments of the auxiliary horn apparatus for the vehicle according to the present invention will be described in detail with reference to the attached drawings.

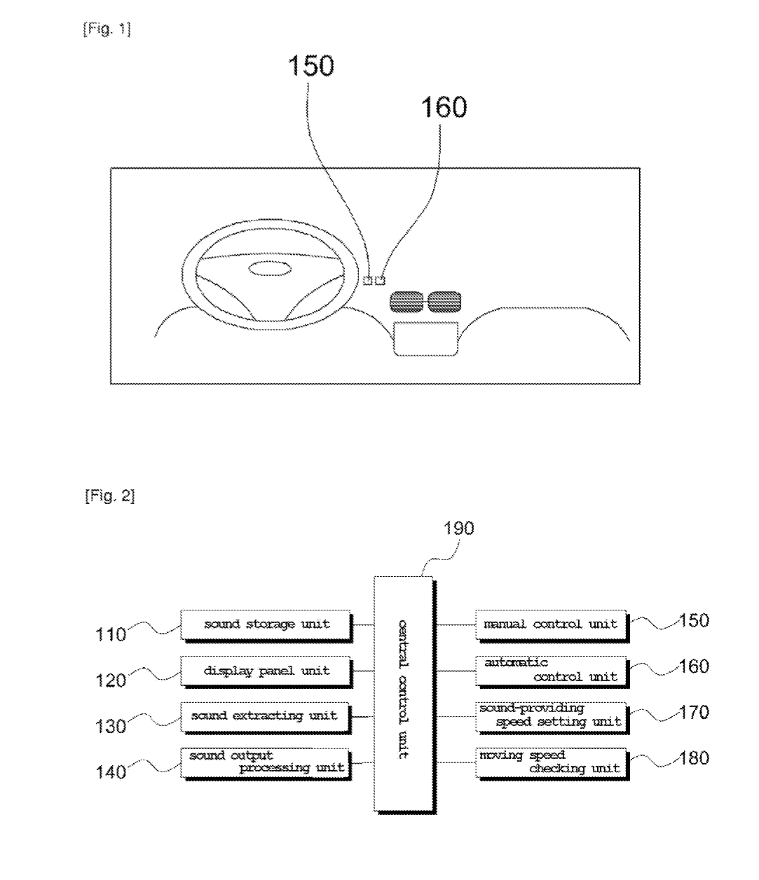

FIG. 1 is an exemplary diagram showing a position where an auxiliary horn apparatus for a vehicle according to the present invention is installed.

As shown in FIG. 1, the manual control unit 150 and the automatic control unit 160 of the auxiliary horn apparatus are disposed at one side of the front face of the vehicle and are selectively pressed when the driver manually or automatically provides a horn sound.

Moreover, the manual control unit 150 and the automatic control unit 160 may be disposed at a handle or may be disposed at any position that the driver can easily use.

There is a difference between the manual control unit 150 and the automatic control unit 160 in that, in an automatic control mode, the auxiliary horn apparatus automatically provides a sound source as a horn sound under a speed previously set by the driver but does not provide a horn sound over the speed previously set by the driver.

Furthermore, in a manual control mode, the auxiliary horn apparatus provides a previously set sound source as a horn sound only when the driver presses the horn manually.

The auxiliary horn apparatus for the vehicle according to the present invention comes in useful even in the case that it is difficult to make a loud horn sound in school zones, on roads inside apartment complexes, or roads where many pedestrians walk during a low speed running of the vehicle. Particularly, the auxiliary horn apparatus for the vehicle according to the present invention can help children, patients, aged people who have slow movements and have lacked concentration on and slow response to surrounding traffic environment and who need care and attention.

FIG. 2 is a block diagram of the auxiliary horn apparatus for the vehicle according to a preferred embodiment of the present invention.

As shown in FIG. 2, the auxiliary horn apparatus for the vehicle according to the present invention includes:

a sound storage unit 110 for storing and managing music information, announcement information, and repeating sound information;

a display panel unit 120 for displaying information for setting one type of sound information stored in the sound storage unit;

a sound extracting unit 130 for extracting the sound information, which is selected from the display panel, from the sound storage unit;

a sound output processing unit 140 for outputting the sound extracted from the sound extracting unit through a speaker;

a manual control unit 150 disposed on the front portion of the vehicle, for transmitting a manual control signal to a central control unit when manipulated;

an automatic control unit 160 disposed on the front portion of the vehicle, for transmitting an automatic control signal to the central control unit, when manipulated;

a sound-providing speed setting unit 170 for controlling a speed in order to automatically output a sound in an automatic control mode;

a moving speed checking unit 180 for checking the moving speed of the vehicle; and

a central control unit 190 for receiving the control signal transmitted from the manual control unit or the automatic control unit, distinguishing the type of the control signal, and when the control signal is the automatic control signal, acquiring the speed information set by the sound-providing speed setting unit, checking the current speed, and determining whether to output a sound.

The sound storage unit 110 stores and manages music information, announcement information, and repeating sound information.

For instance, the music information contains various songs, pop songs, sound effects, and others, the announcement information contains announcement information recorded by a user, announcement information provided by external sound source providers, and others, and the repeating sound information contains various repeating sounds, for instance, sounds of water dripping, cat sounds, horn sounds, and others.

The display panel unit 20 displays the information to the driver so as to set one type of the sound information stored in the sound storage unit.

The auxiliary horn apparatus outputs various sound sources, which the drivers wants to set, on a display screen, and outputs a selection screen so that the driver can select a wanted sound source out of the outputted sound sources.

In this instance, the sound extracting unit 130 extracts the sound information, which is selected by the driver on the display panel unit, from the sound storage unit.

After that, the sound output processing unit outputs the sound extracted from the sound extracting unit through a speaker, and in this instance, a volume of the outputted horn is provided by a sound loudness displayed on the display panel unit.

Technology to control the loudness level of the sound has been known, and hence, its detailed description will be omitted.

The manual control unit 150 is disposed on the front portion of the vehicle, transmits a manual control signal to the central control unit when manipulated, and provides sound information previously set by the central control unit as a horn sound.

Additionally, the automatic control unit 160 is disposed on the front portion of the vehicle, transmits an automatic control signal to the central control unit when manipulated, and continuously provides the previously set sound information as a horn sound only under the speed previously set by the central control unit.

The sound-providing speed setting unit 170 is to set a speed for automatically outputting a sound in the automatic control mode, for instance, the sound-providing speed setting unit 170 obtains a set speed value when the driver set the speed below 20 km.

In addition, a moving speed checking unit is provided in order to check the set speed information of the vehicle, namely, the moving speed of the vehicle.

The central control unit 190 receives the control signal transmitted by the manual control unit or the automatic control unit and distinguishes the type of the control signal.

In this instance, if the control signal is the manual control signal, the auxiliary horn apparatus provides information only when the driver presses the set sound source.

On the contrary, if the control signal is the automatic control signal, the auxiliary horn apparatus acquires the speed information set by the sound-providing speed setting unit and determines whether to output a sound referring to the present speed checked by the moving speed checking unit.

That is, if the speed is below 20 km, the auxiliary horn apparatus transmits an operational signal to the sound output processing unit 140 only when the speed is checked below 20 km and outputs the sound extracted from the sound extracting unit through the speaker.

Through the above structure, the auxiliary horn apparatus according to the present invention provides pedestrians with a sound through the horn in order to let the pedestrians know that an electric vehicle or the latest-model vehicle which makes almost no noise is running, so as to prevent that the pedestrians are in a dangerous situation.

In additional aspect, the auxiliary horn apparatus for the vehicle according to the present invention may further include an external terminal connection unit 210 for renewing and processing the sound information stored in the sound storage unit through communication with an external terminal.

For instance, the external terminal connection unit 210 may be an USB connection port for connection with a portable storage unit, so that the auxiliary horn apparatus can obtain sound information stored in the portable storage unit to renew and process the sound information stored in the sound storage unit.

Moreover, in a further aspect, the auxiliary horn apparatus for the vehicle according to the present invention may further include a sound loudness converting unit 220 for converting a loudness level of the sound extracted from the sound extracting unit every regular cycle.

That is, if the sound source provided as a horn sound is continuously outputted at uniform loudness, it cannot cause any particular attention. Therefore, the auxiliary horn apparatus for the vehicle according to the present invention can convert the sound loudness every regular cycle so as to make the pedestrians pay more attention.

For instance, the loudness level of the horn sound is about 5 dB for ten seconds, is increased to 10 dB for eleven seconds to twenty seconds, and then, is reduced to 5 dB for twenty-one seconds to thirty seconds.

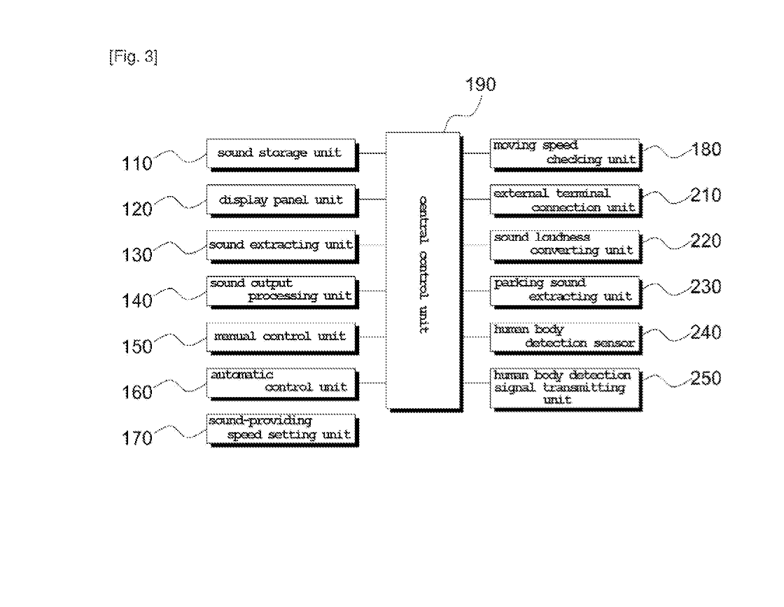

FIG. 3 is a block diagram of the auxiliary horn apparatus for the vehicle according to another preferred embodiment of the present invention.

In the meantime, as shown in FIG. 3, the auxiliary horn apparatus for the vehicle according to the present invention may further include:

a parking sound extracting unit 230 for extracting sound information, which will be outputted at the time of parking, from the sound storage unit;

a human body detection sensor 240 for sensing a human body; and

a human body detection signal transmitting unit 250 for transmitting a detection signal to the central control unit when a human body is detected by the human body detection sensor at the time of parking after checking whether or not the vehicle is parked.

That is, the auxiliary horn apparatus for the vehicle according to the present invention provides the set sound source as the horn sound only when detecting a human body while the vehicle is parked or stopped, so as to prevent a theft case.

The parking sound extracting unit 230 extracts sound information, which will be outputted at the time of parking, from the sound storage unit.

First, the auxiliary horn apparatus provides a setting screen so that the driver can set through the display panel unit not only in the automatic control mode but also at the time of parking.

In this instance, the driver sets a parking sound, and the auxiliary horn apparatus stores the set parking sound information in the sound storage unit.

The human body detection sensor 240 is disposed on the front face or the rear face of the vehicle in order to sense a human body.

In this instance, the human body detection signal transmitting unit 250 checks whether or not the vehicle is parked, for instance, in the automatic control mode, checks whether or not the vehicle is located at P.

When it is checked that the vehicle is located at P, the auxiliary horn apparatus is in a standby state, and then, when the human body detection sensor senses a human body, it transmits a detection signal to the central control unit.

In this instance, the central control unit transmits an operation signal to the sound output processing unit 140, and the sound extracting unit extracts a parking sound, and then, the auxiliary horn apparatus outputs the extracted sound through the speaker.

For instance, the auxiliary horn apparatus outputs announcement information, “Sorry, let me get by.”, below 20 Km and announcement information, “This car is parked for a while, please call if you have any questions or concerns.”, at the time of parking.

Through the above structure and operation, the auxiliary horn apparatus for the vehicle according to the present invention provides pedestrians with a sound through a horn in order to let the pedestrians know that an electric vehicle or the latest-model vehicle which makes almost no noise is running, thereby preventing that the pedestrians are in a dangerous situation.

Moreover, the auxiliary horn apparatus for the vehicle according to the present invention provides previously set sound information during parking only in the case that a human body is detected, so as to prevent a theft case.

It will be understood by those of ordinary skill in the art that the present invention could be made in other forms without changing the technical idea or the essential characteristics of the present invention. Therefore, it would be understood that the embodiments of the present invention have been described exemplarily and the present invention is not limited to the above embodiments. It would be understood that the technical and protective scope of the present invention should be defined not by the embodiments but by the following claims, and the example embodiments of the present invention are to cover all modifications, equivalents, and alternatives derived from the meaning, scope and equivalent concepts of the scope of the invention.

What is claimed is:

1. An auxiliary horn apparatus for a vehicle comprising:
a sound storage unit for storing and managing music information, announcement information, and repeating sound information;
a display panel unit for displaying information for setting one type of sound information stored in the sound storage unit;
a sound extracting unit for extracting the sound information, which is selected from the display panel, from the sound storage unit;
a sound output processing unit for outputting the sound extracted from the sound extracting unit through a speaker;
a manual control unit disposed on the front portion of the vehicle, for transmitting a manual control signal to a central control unit when manipulated;
an automatic control unit disposed on the front portion of the vehicle, for transmitting an automatic control signal to the central control unit, when manipulated;
a sound-providing speed setting unit for controlling a speed in order to automatically output a sound in an automatic control mode; a moving speed checking unit for checking the moving speed of the vehicle;
a central control unit for receiving the control signal transmitted from the manual control unit or the automatic control unit, distinguishing the type of the control signal, and when the control signal is the automatic control signal, acquiring the speed information set by the sound-providing speed setting unit, checking the current speed, and determining whether to output a sound;
an external terminal connection unit for renewing and processing the sound information stored in the sound storage unit through communication with an external terminal;
a sound loudness converting unit for converting a loudness level of the sound extracted from the sound extracting unit every regular cycle;
a parking sound extracting unit for extracting sound information, which will be outputted at the time of parking, from the sound storage unit;
a human body detection sensor for sensing a human body; and
a human body detection signal transmitting unit for transmitting a detection signal to the central control unit when a human body is detected by a human body detection sensor at the time of parking after checking whether or not the vehicle is parked.
